(19) United States
(12) Patent Application Publication
(10) Pub. No.: US 2016/0327655 A1
(43) Pub. Date: Nov. 10, 2016

(54) Conversion Film For Converting Ionizing Radiation, Radiation Detector

(71) Applicant: SIEMENS AKTIENGESELLSCHAFT, München (DE)

(72) Inventors: David Hartmann, Erlangen (DE); Patric Buechele, Erlangen (DE); Sandro Francesco Tedde, Weisendorf (DE); Oliver Schmidt, Erlangen (DE); Joachim Wecker, Roettenbach (DE)

(73) Assignee: Siemens Aktiengesellschaft, Muenchen (DE)

(21) Appl. No.: 15/105,437

(22) PCT Filed: Dec. 10, 2014
(86) PCT No.: PCT/EP2014/077197

§ 371 Date: Jun. 16, 2016

(30) Foreign Application Priority Data
Dec. 18, 2013 (DE) 10 2013 226 338.4
Feb. 28, 2014 (DE) 10 2014 203 685.2

(51) Int. Cl. G01T 1/20

(52) U.S. Cl. CPC G01T 1/2002

(57) ABSTRACT

A conversion film is disclosed for converting ionizing radiation into light and for producing charge carriers via the produced light. The conversion film includes a conversion layer having a plurality of scintillator particles embedded into a binder, wherein the binder contains at least one first organic semiconductor material. A radiation detector for detecting ionizing radiation including such a conversion film is also disclosed, as well as a method for producing such a conversion film. The method for producing the conversion film may include producing a mixture from a plurality of scintillator particles and a binder containing an organic semiconductor material, producing a stratiform structure from the mixture, and forming a conversion layer by solidifying the stratiform structure.

### CROSS-REFERENCE TO RELATED APPLICATIONS

This application is a U.S. National Stage Application of International Application No. PCT/EP2014/077197 filed Dec. 10, 2014, which designates the United States of America, and claims priority to DE Application No. 10 2013 226 338.4 filed Dec. 18, 2013, and DE Application No. 10 2014 203 685.2 filed Feb. 28, 2014, the contents of which are hereby incorporated by reference in their entirety.

### TECHNICAL FIELD

The invention relates to a conversion film with a conversion layer for converting ionizing radiation into light. Furthermore, it relates to a radiation detector for the detection of ionizing radiation with such a conversion film and a method for the production of such a conversion film.

### BACKGROUND

Conversion films are known comprising a plurality of scintillator particles for converting incident ionizing radiation into visible light. Such conversion films are used in medical imaging diagnostics for the detection of X-rays. Conversion films are used to increase the darkening of a photosensitive film or the signal of a photosensor compared with a reaction to unconverted X-rays because films or photosensors react significantly more sensitively to the visible light emitted by the scintillator than to the original X-rays. In addition, in the scintillator every quantum of the X-rays is converted into a plurality of quanta of visible light by the fluorescence of the scintillator material. This is why such conversion films are also described as intensifying screens.

Known conversion films or intensifying screens typically comprise a conversion layer having scintillator particles embedded into a binder, wherein the conversion layer is applied to a carrier film. This carrier substrate may, for example, be made of polyester or cellulose triacetate, in other words, of similar materials to traditional X-ray films. An additional reflective or backscattering layer, for example of titanium dioxide, is often arranged between the conversion layer and the carrier film to deflect the light on this side back into the conversion layer. Extraction of the fluorescent light generated by the scintillator takes place on the side facing away from the substrate. On this side the light is coupled into a film or a photosensor arranged as close as possible. For this purpose, a coupling emulsion adjusted in the refractive index can be arranged between the conversion layer and the film or photosensor.

The scintillator is typically embedded into as transparent a binder material as possible in the form of a luminescent powder. Typical binder materials are resins, thermoplastic elastomers or other transparent organic compounds. On the light extraction side the conversion layer may have a protective layer which in turn is as transparent as possible.

Such conversion films are described in DE 41 42 150 C2 and EP 0 126 564 A2, for example. For production, dispersion is produced from the powdered luminescent material, a binder and often an additional dispersion medium which is then applied to the carrier substrate. The dispersion can be filled in prestructured cells. Then the dispersion is cured. A number of casting resins and transparent polymerizable organic compounds, inter alia, polymethyl methacrylate are described as suitable binder materials.

A disadvantage of known conversion films is the problem of optical distortion. To achieve the most complete absorption and conversion of X-rays into visible light possible, the thickness of the conversion layer needs to be in the region of approximately 100 μm to 800 μm. Above all, at the upper end of this thickness range an optical expansion of the emitted fluorescent light occurs as a result of the thickness of the conversion layer. The reason for this is the isotropic propagation of the light emitted from the point of interaction in the scintillator material. Propagation is therefore undirected and is not channeled in the direction of the film or the photosensor. The greater the layer thickness of the conversion layer and consequently the greater the average distance between the site of interaction and the development of fluorescent light, the more the light is expanded inside the layer. A more blurred image therefore results when the conversion layer is thicker.

The problem of optical distortion is as yet unresolved. In practice, the problem is mitigated by the fact that, depending on the requirements of the diagnostic application, either a thinner film with a lower conversion efficiency but greater image sharpness or a thicker film with a higher conversion efficiency but lower image sharpness is used. Therefore, a compromise must always be reached between the efficacy—and hence the radiation exposure of the patient—and the quality of the image.

A second approach to solving the problem is to apply the scintillator material structured in a kind of needle or column shape to bring about channeling of the emitted light in the direction of the photosensor. This is possible for CsI-based scintillators, in which doped CsI can be grown in columnar structures by means of vapor deposition. This kind of production is very time-consuming, however, and corresponding conversion layers are very expensive compared with traditional conversion films.

Another known approach for detecting X-rays is the use of hybrid organic photodiodes with incorporated scintillator particles. A hybrid photoactive layer is arranged between an electrode and a substrate. The hybrid photoactive layer comprises a plurality of scintillators and a photoactive material in the form of a bulk heterojunction. The bulk heterojunction absorbs the scintillation radiation while forming electron-hole pairs which are then electrically detected.

In professional circles, a phase-separated mixture of an electron donor material and an electron acceptor material is described as a bulk heterojunction, wherein these two components of the mixture each form an interpenetrating network. In particular, this network may be a bicontinuous network, thus enabling a charge carrier pair which is transported on an interface between the donor and acceptor material to be transported from this interface by way of as coherent as possible a transport path in the donor material on one side of the layer and by way of as coherent as possible a transport path in the acceptor material on the other side of the layer. Typically, electrons are attached on two opposite sides of the hybrid photoactive layer by way of which the separate charge carriers, in other words, the electrons and the holes, can be electrically detected.

The production of the hybrid photoactive layers in such well-known photodiodes can take place by means of co-deposition of the scintillator and the material of the bulk heterojunction, wherein the scintillator is present in a suspension and the materials of the bulk heterojunction in a solution. In particular, these two materials can be sprayed onto the substrate simultaneously. This kind of production with liquid precursors is relatively expensive, and material-intensive, however, as there is usually a high loss of material during application, and a deposition of material over and above the dimensions of the substrate to be coated.

Furthermore, glass substrates are often used for the production of known organic photodiodes, which are equipped with regular arrangements of transistors to control individual picture elements. These transistor substrates are typically equipped with regularly structured arrangements of partial electrodes which serve to extract charge carriers for individual sections of the photoactive layers. The traditional deposition of photoactive layers directly onto transistor substrates may result in an undesirably high level of rejection of expensive transistor substrates. Through each additional process step in such complex and integrated detector production, the overall yield declines compared to the material used.

### SUMMARY

One embodiment provides a conversion film for converting ionizing radiation into light and for producing charge carriers by means of the light, the conversion film comprising a conversion layer having a plurality of scintillator particles embedded into a binder, wherein the binder contains at least one first organic semiconductor material.

In a further embodiment, the conversion layer is inherently stable.

In a further embodiment, the conversion layer is arranged on a carrier film.

In a further embodiment, the conversion layer is surface contactable on at least one surface.

In a further embodiment, the binder contains at least two different organic semiconductor materials, of which the first semiconductor material is an electron donor and the second semiconductor material is an electron acceptor.

In a further embodiment, at least one section of the binder is designed as an interpermeating network of domains of the electron donor and domains of the electron acceptor.

In a further embodiment, the binder has an average absorption coefficient of at least 10³ cm⁻¹ for light produced by the scintillator particles.

In a further embodiment, the average particle size of the scintillator particles is between 0.1 μm and 500 μm.

In a further embodiment, the conversion layer is a layer sintered from a powder.

In a further embodiment, the proportional weight of the scintillator particles is between 80% and 98% of the conversion layer.

In a further embodiment, the binder comprises at least one polymeric material.

In a further embodiment, the thickness of the conversion layer is between 10 μm and 1 mm.

In a further embodiment, at least one electrode is arranged on at least a first surface of the conversion layer.

Another embodiment provides a radiation detector for the detection of ionizing radiation having a conversion film as disclosed above.

Another embodiment provides a method for producing a conversion film as disclosed above, the method comprising: production of a mixture from a plurality of scintillator particles and a binder containing an organic semiconductor material, production of a stratiform structure from the mixture and formation of a conversion layer through solidification of the stratiform structure.

### BRIEF DESCRIPTION OF THE DRAWINGS

Example aspects and embodiments of the invention are explained below with reference to the drawings, in which:

FIG. 1 shows a schematic cross-section of a conversion film in accordance with a first example embodiment,

FIG. 2 shows a schematic detailed view of a conversion layer in accordance with a second example embodiment,

FIG. 3 shows a schematic cross-section of a conversion film in accordance with a third example embodiment,

FIG. 4 shows a schematic cross-section of a conversion film in accordance with a fourth example embodiment,

FIG. 5 illustrates an example process of applying a conversion film to a transistor substrate,

FIG. 6 shows a schematic cross-section of a conversion film in accordance with a fifth example embodiment, and

FIG. 7 shows the process of applying a conversion film in accordance with a sixth example embodiment to a transistor substrate.

### DETAILED DESCRIPTION

Embodiments of the present invention specify a conversion film for the conversion of ionizing radiation which avoids the aforementioned disadvantages. Other embodiments specify a radiation detector with such a conversion film and a production method for such a conversion film.

The conversion film may be designed for converting ionizing radiation into light and for producing charge carriers by means of the produced light. It comprises a conversion layer having a plurality of scintillator particles embedded into a binder, wherein the binder contains at least a first organic semiconductor material.

The scintillator particles embedded into the binder bring about the conversion of ionizing radiation into light by exciting fluorescence after absorption of the ionizing radiation. This light may, in particular, lie in the visible range of the wavelength spectrum but alternatively or in addition, it may also comprise adjacent areas of the infrared and/or ultraviolet light. The conversion layer is designed in such a way that the production of free charge carriers can be brought about by the emitted light in the area surrounding the scintillator particles. In particular, this production can take place in the binder and/or in an additional coating of the scintillator particles. The emitted light can bring about the formation of an excited state in a material surrounding the scintillator particles, which in turn results in the formation of separate positive and negative charges. A so-called charge carrier pair is thus formed. The conversion layer is designed in such a way that this charge carrier pair can be separated. The conversion layer comprises at least a first organic semiconductor material for this purpose. Expediently this organic semiconductor material may be either a material acting as an electron donor for transporting positive charge carriers (holes) or it may be a material acting as an electron acceptor for transporting negative charge carriers (electrons). At least one of the two kinds of charge carriers (electrons or holes) can therefore be transported in the first organic semiconductor material. The oppositely charged other kind of charge carrier may expediently be transported in a further material present in the conversion layer. This additional material may alternatively be designed as a further organic semiconductor or also more broadly as a conducting material, for example, as an inorganic semiconductor or as a hybrid material with inorganic and organic components.

An advantage of the disclosed conversion film compared with traditional conversion films or intensifying screens is that scintillator material and a further material for producing separate charge carriers are incorporated in one layer by the light emitted by the scintillator. The separated charge carriers can be extracted from this layer by further electrodes. During use, these electrodes can be included in a radiation detector in an electrical circuit which is designed to produce an electrical signal which depends on the number of extracted charge carriers.

The advantage of the inclusion of light production and charge separation in one conversion layer is that the problems of optical distortion described above are avoided with greater layer thicknesses. The conversion layer can be designed with a sufficiently great layer thickness for good absorption of X-rays without this resulting in a loss of image sharpness as a result of optical distortion. The production of separated charge carrier pairs by the emitted light takes place by means of the embedding of the scintillator particles in the semiconductor material very close to the place where the light is produced. The subsequent transport of the charge carrier to opposite surfaces of the conversion layer can take place in a highly focused manner by applying a voltage to electrodes positioned there. A spatial expansion of the charge carrier and a consequent loss of image sharpness are advantageously avoided by this means.

Compared with known hybrid organic photodiodes, an advantage of the disclosed conversion film is that the film is designed as an independent flexible component. The conversion film may expediently be free of switching elements, in particular, free of read-out transistors. It may be provided as a modular component for this purpose, to be subsequently linked to an arrangement of read-out transistors. In particular, the conversion film can be linked to a transistor substrate as a self-supporting film after its production.

Through the production of the conversion film without an underlying transistor substrate, process parameters which are incompatible with a transistor substrate may be selected. In particular, temperature and pressure ranges may be selected which would lead to damage of the transistor substrates or at least to a yield loss during processing on transistor substrates.

The modularity of the conversion film makes it possible to simplify the production of an organic photodiode with a hybrid conversion layer. For example, the conversion layer can be produced entirely without the use of a carrier substrate, thus enabling completely new production methods. Unlike traditional coating methods, in which a substrate is coated with a liquid solution and/or a suspension of a solid substance is coated in a liquid, an inherently stable film can also be rolled or extruded from highly viscous source materials without a substrate. These source materials may, for example, be dispersions of solid scintillator particles in a polymer or in one or more source materials for a polymer.

Alternatively, the source materials for the conversion layer may also be present in the form of a mixture of solids or a moistened powder mixture. For the production of the conversion film, this conversion layer may be supported on a temporary substrate from which it can be released again after solidification of the conversion layer, for example.

For the production of the conversion layer from highly viscous and/or solid source materials, the utilization of material can be significantly improved compared with production from the low-viscosity liquid phase.

The disclosed radiation detector for the detection of ionizing radiation comprises at least one conversion film. The advantages of radiation detectors are analogous to the aforementioned advantages of the conversion film according to the invention.

The disclosed method for producing the conversion film may include the following steps:
Production of a mixture from a plurality of scintillator particles and a binder containing an organic semiconductor material,
Production of a stratiform structure from the mixture and
Formation of a conversion layer through solidification of the stratiform structure.

An advantage of the disclosed method is that the conversion film according to the invention can be produced in a simple and material-saving manner. Further advantages are produced analogously to the aforementioned advantages of the conversion film. Thus, in particular, the method for producing a radiation detector according to the invention can be simplified as the entire production process can be divided into several modular subprocesses independent of each other. The production of a self-supporting conversion layer as a supplier part for the radiation detector is possible.

In some embodiments, the conversion film may also have one or more of the following features:

The conversion layer may be inherently stable in design. It may, therefore, be so stable that it is even self-supporting without a substrate. It can be handled and/or processed as an independent, substrate-free layer. There is nothing to prevent it, for example, from being placed on a temporary substrate during the production process but in any case it is then so inherently stable that it can be released from such a substrate again non-destructively. Alternatively or in addition to such a substrate, during production the conversion layer may in turn be linked to further supporting films or other substrates before its use for radiation detection. It is only a matter of the conversion layer being so inherently stable that it permits handling, transport and/or processing without an additional supporting carrier substrate.

The conversion layer comprises a plurality of scintillator particles embedded into a binder. In particular, the choice of binder is so stable that the conversion layer has the requisite inherent stability. The binder can therefore bring about sufficiently stable cohesion of the scintillator particles. Alternatively or in addition, cohesion between the adjacently arranged scintillator particles may also be so pronounced that the conversion layer already obtains its inherent stability without being reinforced by the binder.

As a result of the inherently stable embodiment of the conversion layer, for example, only this layer can be manufactured as an independent intermediate product, stored and, if necessary, used for the production of a radiation detector according to the invention. Advantageously, the conversion layer is sufficiently mechanically and chemically stable to be stored for periods of months or years and placed on the market as an individual product. As a result, the production process of the radiation detector can be decoupled in various independent subprocesses which, for example, are performed with a time lag and/or at different locations.

The conversion layer can be arranged on a carrier film. In particular, this carrier film may also be part of the conversion film and give the actual conversion layer additional mechanical stability. When using the conversion film in a radiation detector, such a carrier film can either remained connected to the conversion layer, or it can be released from the conversion layer again as a temporary substrate. In any case, with these embodiments it is expedient if a flat electrode is arranged between the conversion layer and the carrier film which enables the extraction of charge carriers to the adjacent surface of the conversion layer. The carrier film may preferably comprise, for example, a polymeric material and/or a metallic film. The function of the flat electrode may also be assumed by the carrier film, for example, in the case of a metallic film.

The conversion layer may be surface contactable. In other words, a flat electrical contact can be created to the enclosing organic semiconductor material on at least one of its two main surfaces. For example, the conversion layer may be freely accessible on at least one of its two main surfaces. Then a flat contact with a contact surface of another component can be created on this freely accessible side. For example, the freely accessible side may be electrically connected to the contact surfaces of a structured transistor substrate. Alternatively, the conversion layer may already be equipped with a flat electrode on at least one of its two main surfaces. In particular, this flat electrode may be divided into partial electrodes which, for example, can be connected to the contact surfaces of a structured transistor substrate. With embodiments in which the conversion layer is arranged on a carrier film, expediently the surface contactable side of the conversion film is the side facing away from the carrier film.

The binder may comprise at least two different organic semiconductor materials of which the first semiconductor material is an electron donor and the second semiconductor material an electron acceptor. Thus, the first semiconductor material is particularly suited to the transport of positive charge carriers and the second semiconductor material is particularly suited to the transport of negative charge carriers. In this embodiment both types of charge carrier separated in the conversion film are therefore transported by organic semiconductor materials. The absorption of the light generated by the scintillator can take place either in the material of the electron donor and/or in the material of the conversion layer of the electron acceptor and/or in an additional material in the vicinity of the scintillator particles. So-called excitons are formed in the absorption material constituting the associated charge carrier pairs in an excited state. These excitons may diffuse at the interface between donor material and acceptor material and at this interface they are advantageously separated into the two different charge carriers which can then be transported away from each other in the two different materials.

The binder of the conversion layer may be formed as an interpenetrating network of domains of the electron donor and domains of the electron acceptor, at least in a subsection. In other words, the binder may comprise a so-called bulk heterojunction. Particularly advantageously, the interpenetrating networks of the two materials form a common bicontinuous network, i.e. in each of the two domains there are associated paths in the direction of at least one respective surface of the conversion layer from the interfaces between the domains. It should not be ruled out that, in addition, islands of one of the domains or of both the domains may also be present. However, such an associated path is advantageously formed in each of the two materials for the majority of the interface formed between the domains of the two materials. Such a bulk heterojunction may form as a result of phase separation of a mixture of the associated material.

The binder may have an average absorption coefficient of at least 10³ cm⁻¹ for the light generated by the scintillator particles. The average absorption coefficient is a value averaged over the various components of the binder and over the different wavelengths of the light emitted. Particularly advantageously, the average absorption coefficient may be at least 10⁴ cm⁻¹.

Such a high absorption coefficient represents a major difference compared to the properties of the binder material in known self-supporting conversion or intensifying screens. In the case of traditional intensifying screens, the binder must be as transparent as possible so that the highest possible proportion of emitted light can reach light sensors located outside the film. In the case of the present invention, however, it is advantageous if the binder is as absorbent as possible so that an exciton can be formed as close to the origin of the light as possible and separation of the charge carrier can thus take place as close as possible too. As a result of this physical proximity of the place of origin of the separate charges to the place of origin of the light, unnecessary optical expansion and consequent blurring of the image created is advantageously avoided.

The average particle size of the scintillator particles may advantageously be between 0.1 μm and 500 μm, particularly advantageously it may be between 1 μm and 50 μm. Towards the bottom, the advantageous values for the size of the scintillator particles are limited by the interaction length of the high-energy electrons released by the X-rays. Furthermore, it has been shown that due to the less favorable volume-to-surface ratio small scintillator particles typically have higher defect densities and as a result a non-radiating recombination of excited states is observed. With particle sizes which are too small, the strength of light emission is therefore too low. Towards the top, on the one hand the size of the scintillator particles is limited by the thickness of the conversion layer and on the other hand also by the desired high efficiency of charge carrier transport.

The particle sizes of the scintillator particles may be subject to frequency distribution. For example, the half width of such distribution may advantageously be at least 30% of the average particle size.

Advantageously, size distribution may essentially follow the so-called Fuller curve:

D_i=(d_i/d_max)̂n

where d_i describes a predefined particle size, D_i the cumulative proportion of the particles up to this size d_i, d_max the maximum particle size and n the distribution module. The distribution module constitutes a geometry factor which assumes a value of 0.5 for spheres and decreases for elongated or flattened particles. For a distribution module of 0.35 and a maximum particle size of 10 μm, approximately half the particles of the mixture should therefore be smaller than 1.4 μm.

With such distribution it is possible for the scintillator particles to achieve a particularly high packing density as the smaller particles can fill the gaps inevitably occurring between larger particles. The high packing density of the scintillator particles advantageously results in particularly high absorption and conversion of ionizing radiation with the smallest possible overall thickness of the conversion layer and thus with less use of the binder and expensive organic semiconductor materials.

Alternatively, however, it is also possible to use a scintillator particle with a relatively uniform size, for example, with a half width of distribution of at most 10%, in order to achieve the most uniform and defined packing possible, for example, using spherical scintillator particles a kind of regular sphere packing can thus be formed.

Alternatively, a mixture of scintillator particles with two predominant, relatively uniform sizes can also be used, wherein the smaller particles are suitable for filling the spaces in the densest packing possible of the larger particles.

The conversion layer may comprise a layer of sintered powder. Such a sintering process is particularly well suited to the production of a stable layer with a high density of scintillator particles as the source material used is consolidated and condensed by the sintering process. The powder used for this may in particular be a dry powder which contains a mixture of scintillator particles and one or more organic semiconductor materials. Alternatively, the powder may also be a slightly moistened powder with such a mixture and a liquid moistening this mixture. The process of sintering is a compaction of the powder used under the influence of pressure and where applicable, temperature. The sintering pressure may advantageously be between 0.5 and 200 MPa, particularly preferably between 1 and 50 MPa. The pressure may, for example, be exerted by means of a stamp, a roll or a roller system on the layer of powder. The stamp, roll and/or roller may be coated with a non-stick coating, for example, with Teflon, so that the sintered layer can be easily released from the tool after the process. In addition, with tools coated in this way extremely homogenous, smooth surfaces are obtained. Sintering of the layer can either take place on a layer which is self-supporting from the start, for example, in a roller system or by means of pressing onto a temporary substrate from which the sintered layer can then be released again.

The temperature of the sintering process may advantageously be between 30° C. and 300° C., particularly advantageously between 50° C. and 200° C. Depending on the temperature selected, both solid phase sintering, hence material compaction without melting of the organic material, or liquid phase sintering, hence material compaction by way of the at least proportionate melting of the organic material, are conceivable. By compacting the material by means of pressure and if necessary, temperature, the spaces are minimized and compacted such that when an electric voltage is applied, electrical charge transport for example, by means of hopping or redox processes is possible between the individual organic molecules and/or polymer strands. In this way, homogenous organic material layers of a predefined thickness can be realized without costly vacuum process technology with high throughput and without health hazards from any solvents.

Due to the high pressures and temperatures which may occur during sintering, the direct application of the conversion layer on a substrate is often difficult. For example, plates with thin-film transistors of amorphous silicon on glass substrates may be damaged by the effect of pressure and/or temperature. The present invention enables the separate production of the conversion film and subsequent bonding with the readout substrate.

Conversion layers produced by sintering can be established and characterized on the basis of the morphology and the surface condition of the sintered layer, for example, through the detection of areas of the compacted source powder melted individually or over entire surfaces. Indirect conclusions may also be drawn about a sintering process, for example, as a result of a lack of traces of solvent and/or additives. Investigative methods worth considering are, for example: optical microscopy, scanning electron microscopy, atomic force microscopy, secondary ion mass spectrometry, gas chromatography and cyclic voltammetry.

A multiplicity of scintillator particles may have a coating of at least one photoactive material. In particular, the photoactive material may be an organic semi-finished material. Such a coating or cover can be achieved expediently by coating the scintillator particles used before production of the conversion layer. A major advantage of such a coating is that a conversion layer with a high volume fraction of scintillator particles can be produced, wherein nonetheless the spaces between directly adjacent scintillator particles are at least partially filled with organic semiconductor material. Thus, in these spaces the emitted light can be absorbed and the charges in these spaces separated. By observing a predefined distance between the scintillator particles on account of the coating, conductive channels can form in the at least one organic semiconductor material by way of which separated charge carriers can be transported to the respective surfaces of the conversion layer.

Particularly advantageously, a multiplicity of scintillator particles are coated with a mixture of an organic donor material and an organic acceptor material which forms a structure in the manner of a bulk heterojunction. Then the light of the scintillator particles can be absorbed in this bulk heterojunction, separated charge carriers can be produced as a result, and the separated charge carriers can be transported through the domains of the respective donor or acceptor components to various surfaces or various areas on a surface of the conversion film.

Advantageously, the spaces between the coated scintillator particles can also be at least partially filled with an additional material. In particular, the coated scintillator particles can be embedded into a binder which contains at least a first organic semiconductor material. The binder can also preferably be a mixture of an electron donor and an electron acceptor in the manner of a bulk heterojunction.

Alternatively, however, the binder according to the invention can already be formed of the material of the cover or coating of the scintillator particles. For example, coated scintillator particles can be compacted by means of a sintering process such that by grouting and/or melting the coating of the individual scintillator particles, a stable coherent structure is produced. Advantageously, with such a sintered layer at least some of the directly adjacent scintillator particles may be spaced by means of an intermediate layer of the material of the coating. In this embodiment, gaps between the coated scintillator particles may optionally be filled with an additional material which can contribute to the mechanical strength of the conversion film but need not contain any additional organic semiconductor material itself. For example, such an additional filler may be a non-conductive polymer material. In this embodiment the conductivity required for the transport of the separated charge carrier can only be ensured by the channels formed in the coating material.

The coating of photoactive material may cover an average of at least 80%, particularly preferably at least 95% of the entire outer surface of the scintillator particles.

The coating of the scintillator particles may advantageously have an average thickness of 15 nm to 1500 nm, particularly preferably of between 150 nm and 600 nm. Furthermore, the average thickness of the coating may preferably correspond to a maximum penetration depth of 2.5 times the emitted radiation of the scintillator particles so that the average direct distance of uncoated scintillator particles advantageously corresponds to a maximum of five times the penetration depth of the radiation.

The scintillator particles may have a proportional weight of between 80% and 98% of the conversion layer. Such a high proportional weight is advantageous in achieving high absorption of the ionizing radiation in the conversion film. At the same time, the proportion of other components of the conversion film, hence in particular the proportion of the binder and if applicable, of an additional coating material should not be unnecessarily high in order to keep the production costs as low as possible. A common proportional weight of these other components of at least 2% is advantageous in enabling the most continuous network of conductive material possible for transporting the separated charge carriers to the surface of the conversion film.

The binder may advantageously comprise at least one polymer material, in particular an organic polymer material. The use of a polymer material may advantageously result in particularly high strength and mechanical resilience of the conversion film. It is possible that stable cohesion of the film with a high proportion of scintillator particles is only achieved at all by using a polymer material as part of the binder. Such a polymer material may, for example, be a polymer organic semiconductor which then preferably performs the function of conductivity for at least one type of charge carrier and at the same time, the function of mechanical cohesion. In an alternative embodiment, however, the polymer material may also be non-conductive and only serve as a support material for one or more conductive components present in the binder.

Examples of such non-conductive polymer materials are polymethyl methacrylate, polyester or cellulose triacetate.

The layer thickness of the conversion layer may advantageously be between 10 μm and 1 mm, particularly advantageously between 50 μm and 500 μm. A conversion layer embodied in this way is thick enough to ensure sufficiently high absorption and conversion of the ionizing radiation. On the other hand, it is sufficiently thin to enable efficient extraction of the separate charge carriers by an electric field applied to the outer surfaces of the film.

The absorption of the conversion film for X-rays with energy of 60 keV may advantageously be at least 50%, particularly advantageously at least 70%. This should apply in particular to the vertical passage of the radiation through the film.

The light wavelength of at least one maximum emission of the scintillator particles may be within the range of maximum absorption of the binder. In other words, the absorption spectrum of the binder may be advantageously adjusted to at least a subsection of the emission spectrum of the scintillator particles. The emission bands of the scintillator particles should therefore overlap with at least one absorption band of at least one component of the binder. As a result of this, a high degree of efficiency can be achieved for the production of separate charge carriers as a result of the light emitted by the scintillator.

The choice of particularly appropriate materials for the components, in particular the light-absorbing components of the binder, therefore depends on the choice of material for the scintillator particles. Exemplary combinations of materials for a combination of scintillator particles with photoactive organic materials for various wavelengths are as follows:

Suitable green scintillators are, for example, Gd₂O₂S:Pr,Ce (gadolinium oxysulfide, doped with praseodymium and cerium with a maximum emission of approximately 515 nm), Gd₂O₂S:Tb (gadolinium oxysulfide, doped with terbium with a maximum emission of approximately 545 nm), Gd₂O₂S:Pr,Ce,F (gadolinium oxysulfide, doped with praseodymium or cerium or fluorine with a maximum emission of approximately 510 nm), YAG:Ce (yttrium-aluminum-garnet doped with cerium with a maximum emission of approximately 550 nm), CsI:Tl (cesium iodide, doped with thallium with a maximum emission of approximately 525 nm), CdI₂:Eu (Europium-doped cadmium iodide with a maximum emission of approximately 580 nm) or Lu₂O₃:Tb (lutetium oxide doped with terbium with a maximum emission of approximately 545 nm). These green scintillators are characterized by a maximum emission in the range of 515-580 nm and are therefore well equipped for the maximum absorption of poly(3-hexylthiophene-2,5-diyl) (P3HT) as an exemplary photoactive material of the organic matrix at 550 nm. The scintillator Bi₄Ge₃O₁₂ or BGO (bismuth germanate with a maximum emission of approximately 480 nm) combines well with poly [2-methoxy-5-(2-ethylhexyloxy)-1,4-phenylenvinylene] (MEH-PPV) or poly[2-methoxy-5-(3′,7′-dimethyloctyloxy)-1,4-phenylenvinylene] (MDMO-PPV), which absorb well in the range of 460-520 nm.

Suitable blue scintillators must also be mentioned. An attractive material combination with emission in the blue range are Lu₂SiO₅:Ce or LSO (cesium-doped lutetium oxyorthosilicate with maximum emission of approximately 420 nm), Lu_{1.8}Y.₂SiO₅:Ce (lutetium oxyorthosilicate doped with cerium with a maximum emission of approximately 420 nm), CdWO₄ (cadmium tungstate with a maximum emission of approximately 475 nm), CsI:Na (cesium iodide doped with sodium with a maximum emission of approximately 420 nm), or NaI:Tl (thallium-doped sodium iodide with a maximum emission of approximately 415 nm), Bi₄Ge₃O₁₂ or BGO (bismuth germanate with a maximum emission of approximately 480 nm), Gd₂SiO₅ or GSO (gadolinium oxyorthsilicate doped with cerium with a maximum emission of approximately 440 nm), or CsBr:Eu (cesium bromide doped with europium with a maximum emission of approximately 445 nm), which combines well with typical wide bandgap semiconductors (semiconductors with a wide bandgap) such as poly[(9,9-di-n-octylfluorenyl-2,7-diyl)-alt-(benzo[2,1,3]thiadiazole-4,8-diyl)] (F8BT) with maximum absorption at 460 nm or other polyfluorene (PFO) polymers and co-polymers with absorption at 380-460 nm.

Red scintillators such as Lu₂O₃:Eu (lutetium oxide doped with europium with a maximum emission of approximately 610-625 nm), Lu₂O₃:Tb (lutetium oxide doped with terbium with a maximum emission of approximately 610-625 nm) or Gd₂O₃:Eu (gadolinium oxysulfide doped with europium with a maximum emission of approximately 610-625 nm), YGdO: (Eu,Pr) (europium and/or praseodymium-doped yttrium gadolinium oxide with a maximum emission of approximately 610 nm), GdGaO:Cr,Ce (chromium and(or cesium-doped gadolinium gallium oxide), or CuI (copper iodide with a maximum emission of approximately 720 nm) can be combined well with absorbers, as developed for organic photovoltaics, for example, Poly[2,1,3-benzothiadiazole-4,7-diyl[4,4-bis(2-ethylhexyl)-4H-cyclopenta[2,1-b:3, 4-b′]dithiophen-2,6-diyl]] (PCPDTBT), squaraine (e.g. hydrazone end-concealed symmetrical squaraine with glycolic functionalization or diazulene squaraine), polythieno[3,4-b]thiophene (PTT) or poly(5,7-bis(4-decanyl-2-thienyl)-thieno(3,4-b)diathiazole-thiophene-2,5) (PDDTT).

Particularly worthy of mention among these pairs in accordance with preferred embodiments are: Gd₂O₂S:Tb or YAG:Ce in combination with P3HT, Lu₂SiO₅:Ce in combination with F8BT or YGdO:Eu with PCPDTBT. In these examples, the organic semiconductors P3HT, F8BT and PCPDTBT each simultaneously fulfill the function of the absorbent components and the hole-conductive electron donor components of the binder.

Particularly appropriate materials for an electron-conducting acceptor component of the binder are fullerenes and their derivatives such as, for example, [6, 6]-phenyl-C₆₁-butanoic acid-methyl ester (PCBM).

The conversion film may comprise at least one first electrode which is preferably arranged on at least one first surface of the conversion layer. Particularly preferably, the conversion film may comprise at least two electrodes which can be expediently arranged on opposite surfaces of the conversion layer. Preferably these two electrodes are designed for extraction of the two different types of charge carrier, in other words, they may be an anode and a cathode.

At least one of the two electrodes may be extensive in design, in other words, it may cover the majority of one of the surfaces of the conversion film. Both electrodes may also be extensive in design.

At least one of the electrodes may also be structured in design, in particular it may be a regular arrangement of partial electrodes. For example, at least one electrode may be divided into a plurality of partial electrodes of the same kind to enable the readout of a spatial image of ionizing radiation in a plurality of picture elements (pixels). To this end, in particular it is advantageous if an electrode is extensive in design and an opposite electrode on the other side of the conversion film is structured in individual pixels. The structured electrode may be either the anode or the cathode. However, it is also possible that both electrodes are divided into individual pixels.

Advantageously, the at least one structured electrode may be between 0.3 μm and 100 μm, particularly advantageously between 0.3 μm and 30 μm, in size in one or in both spatial directions.

Suitable materials for the electrodes are metals such as aluminum, silver and gold or conductive oxides such as, for example, indium tin oxide.

Alternatively or in addition to such electrode layers, on at least one surface the conversion film may be equipped with a contact material which is designed as an extensive film with anisotropic conductive properties.

In an alternative embodiment, the conversion film may be free of electrodes. Suitable electrodes for extraction of the charge carrier from the conversion layer may then, for example, be connected to the conversion film as a further component of a radiation detector in a subsequent step.

Optionally, the conversion film may also comprise at least one intermediate layer between the conversion layer and one of the electrodes. One such intermediate layer may, for example, either be designed as a hole blocking layer or as an electron blocking layer.

The conversion film may optionally have one or more additional protective layers which prevent the penetration of dust, water and/or oxygen into the film and associated aging. This protective layer may be designed in such a way that during processing in a detector it is removed before connection to a substrate or remains in the finished part. For example, a first protective film can remain on the upper side as a water and oxygen barrier, while a second protective film on the underside is removed before the underside is connected to a substrate, for example, a transistor matrix.

The conversion film may optionally have an adhesive layer which makes connection to a substrate easier. The adhesive layer may, for example, be designed as an anisotropic conductive adhesive and can be covered by a protective film until assembly.

The radiation detector for the detection of ionizing radiation with the conversion film may also have the following additional features:

Expediently, it may comprise at least one electrode which is arranged adjacent to a first surface of the conversion layer. In addition, it may comprise a second electrode which is arranged adjacent to a second surface of the conversion layer. Advantageously, these two electrons may be arranged on opposite surfaces, in particular the two main surfaces of the conversion layer. One of these two electrodes or both electrons may either be part of the conversion film already or they may be present in the radiation detector as additional elements subsequently associated with the conversion film.

The electrodes are expediently used to electrically transport the two separate types of charge carrier from the conversion film. Expediently, one electrode can be designed as a cathode and the second electrode as an anode.

An intermediate layer may optionally be arranged between the conversion layer and at least one of the two electrodes as well. This intermediate layer may be a hole blocking layer which is designed to transport electrons and/or to block holes (positive charge carriers). Alternatively or in addition, it may be an electron blocking layer which is designed to transport holes and/or to block electrons.

Furthermore, the radiation detector may be divided into individual picture elements, for example, by structuring at least one of the electrodes into a plurality of partial electrodes. In this embodiment the radiation detector may furthermore comprise a plurality of switching elements for control and/or readout of the individual picture elements. In particular, each picture element may be assigned one or more switching elements. The switching elements may, for example, be transistors, in particular thin-film transistors of amorphous silicon.

A particular advantage of such a radiation detector is that as a result of the use of the self-supporting conversion film according to the invention, no complex process steps need be performed on the sensitive switching elements. In particular, the production of the conversion layer need not take place on the sensitive switching elements but the finished conversion film can be subsequently connected to these switching elements. For example, a glass plate which has a plurality of thin-film transistors can be subsequently connected to the conversion film already produced. The thin-film transistors can already be equipped with an electrode and connected to a conversion film which only has an extensive contact on the opposite side. Alternatively, the conversion film may already be equipped with electrodes during its production, or it can be provided with electrodes subsequently, for example, only when connected to the transistor substrate. The transistors may advantageously be thin-film transistors of amorphous silicon or a metal oxide.

In any case, the subsequent connection of an arrangement of switching elements to the completed conversion film has the advantage that the material yield can be significantly improved. In particular, there is no unnecessary rejection of transistor plates during the deposition of a complex layer system of scintillator particles and organic semiconductor materials.

Besides the aforementioned versions, the method for producing the conversion film may have the following additional features:

Before the production of the conversion layer, the scintillator particles may be provided with a coating which contains at least one photoactive material, in particular a photoactive organic semiconductor.

The conversion layer may be produced by sintering a source material in powder form. In particular, an inherently stable conversion layer can be created in this way.

The conversion layer can be produced and/or consolidated by means of polymerization of at least one component of the binder.

The conversion film can be produced by means of an extrusion method. Particularly advantageously, with this embodiment one or more electrodes can also be applied by means of co-extrusion of a conversion layer and an electrically conductive material. For example, conductive flat silver particles can be co-extruded together with the conversion layer. Alternatively or in addition, the conversion layer can also be co-extruded with a carrier film.

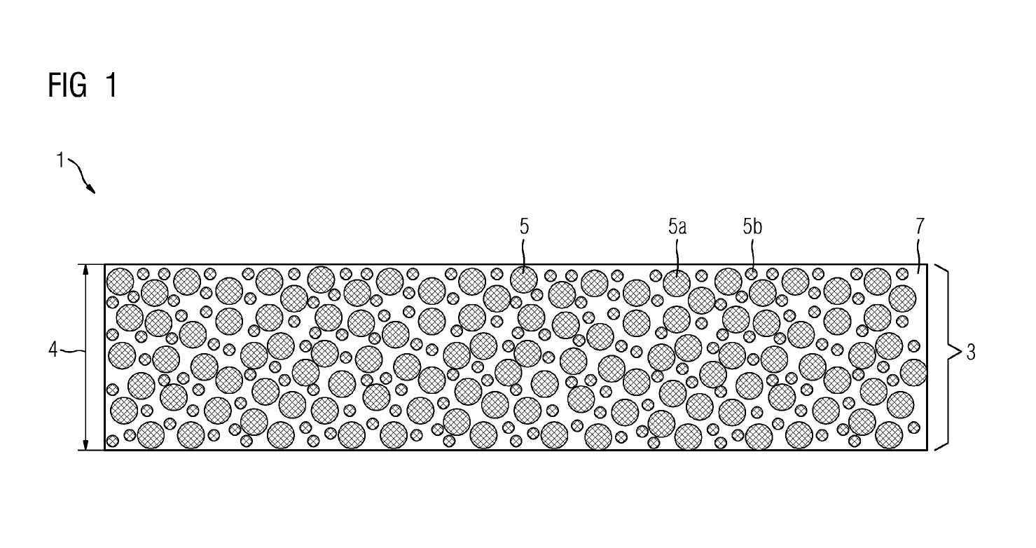

FIG. 1 shows a schematic lateral cross-section through a conversion film 1 in accordance with a first exemplary embodiment of the invention. A self-supporting conversion layer 3 is shown which in this example is substrate-free and has no additional associated electrodes or additional flat layers. In this example, the conversion film therefore solely comprises the conversion layer 3. The conversion layer 3 has a plurality of scintillator particles 5 which are embedded into a binder 3. The scintillator particles 5 essentially consist of Gd₂O₂S:Tb, in other words, of terbium-doped gadolinium oxysulfide. This scintillator is a material which absorbs X-rays well and emits green light after excitation with ionizing radiation.

The scintillator particles 5 are embedded into a binder 7 absorbent in the green range of the spectrum which confers self-supporting properties on the conversion layer 3 of the film 1. The scintillator particles 5 display a size distribution with two distinct maxima and a mixture of larger particles 5a and smaller particles 5b is therefore present. By this means, particularly high utilization of space of the volume of the conversion layer 3 can be achieved by the scintillator particles 5. The proportional weight of the scintillator particles 5 is still much higher than the volume fraction as the scintillator particles 5 have a significantly higher density than the binder 7 so that the ionizing radiation is essentially absorbed in the scintillator particles 5.

In the example shown, the binder 7 is a mixture of the polymer P3HT (poly(3-hexylthiophene-2,5-diyl)) light-absorbent and hole-transporting in the green range and the electron-transporting fullerene derivative PCBM ([6,6]-phenyl-C₆₁-butanoic acid methyl ester). These two materials form a phase-separated bulk heterojunction in the binder 7, in which after light absorption by P3HT, separation and then separate transport of the two types of charge carrier to the upper and lower surfaces of the conversion layer 3 in FIG. 1 can take place. The polymeric material P3HT confers sufficient strength on the conversion layer 3 to enable handling without a carrier substrate. In this example the conversion layer 3 is produced by sintering a mixture in powder form from the scintillator particles, P3HT and PCBM.

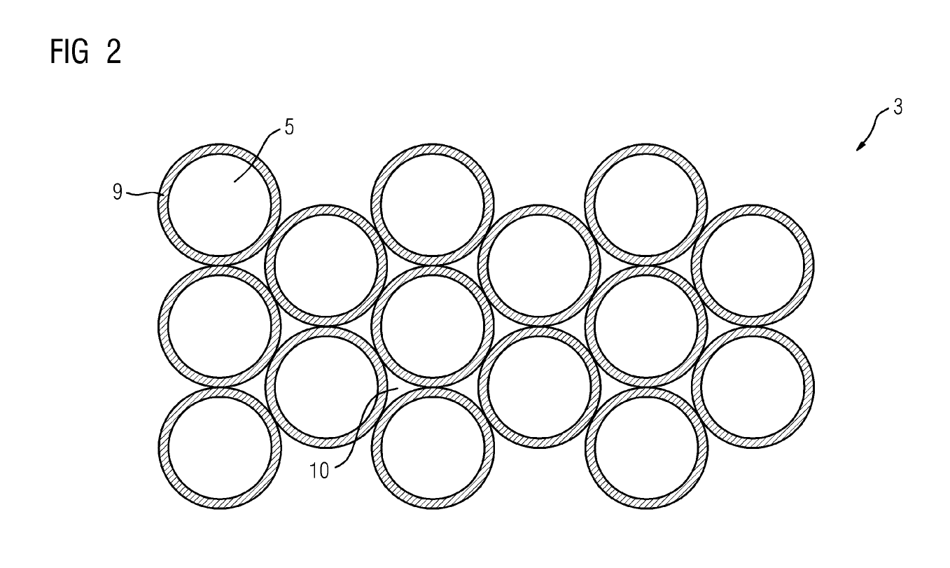

FIG. 2 shows a detailed view of a conversion layer 3 in accordance with a second exemplary embodiment of the invention. In this example, a plurality of scintillator particles 5 of a similar size are each provided with a coating 9. The coating 9 here is in turn a mixture of P3HT and PCBM, which forms a bulk heterojunction. The conversion film 3 in accordance with this second exemplary embodiment was also obtained through sintering of a mixture of the particles 5 coated in this way, wherein during the sintering process the coatings 9 of the individual particles melt to form a continuously conducting network. In this case, the fused coatings 9 therefore also act as a binder 7. In addition, however, the additional spaces 10 between the coated particles 5 can also be filled with additional binder 7, for example, in turn with a P3HT/PCBM mixture or with another material supporting mechanical strength.

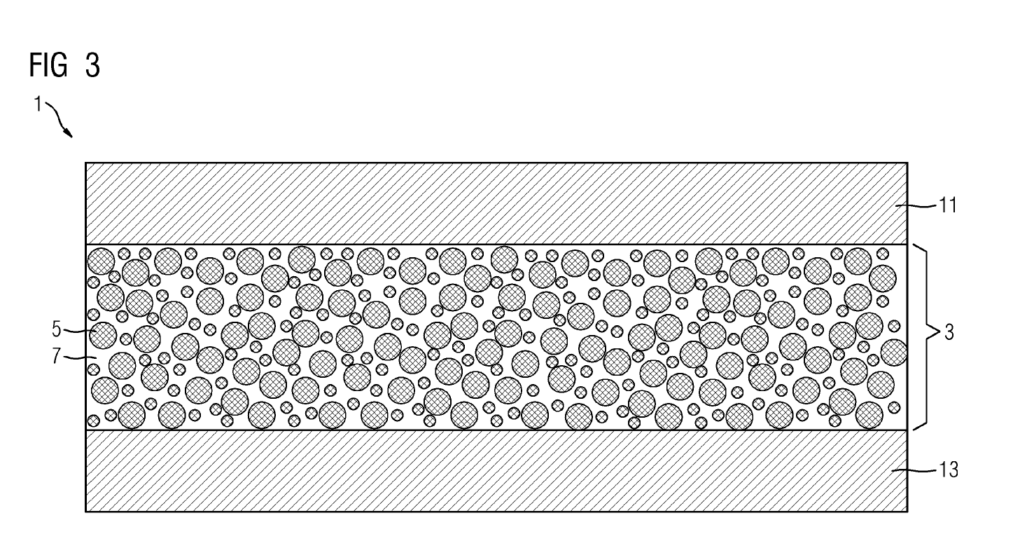

The conversion layer 3 shown in FIG. 1 is not yet equipped with electrodes and as a self-supporting film 1 can be stored as an independent component or put on the market. Later the conversion layer 3 can also be equipped with electrodes. FIG. 3 thus shows a schematic cross-section through a conversion film 1 in accordance with a third exemplary embodiment in which the conversion layer 3 was supplied with two metal electrodes 11 and 13 through lamination of thin films. These electrodes act as an anode and a cathode and serve to extract the two types of charge carrier on opposite surfaces of the conversion layer 3. The conversion film can either be stored with or without such electrodes 11 and 13 and/or put on the market as an independent product.

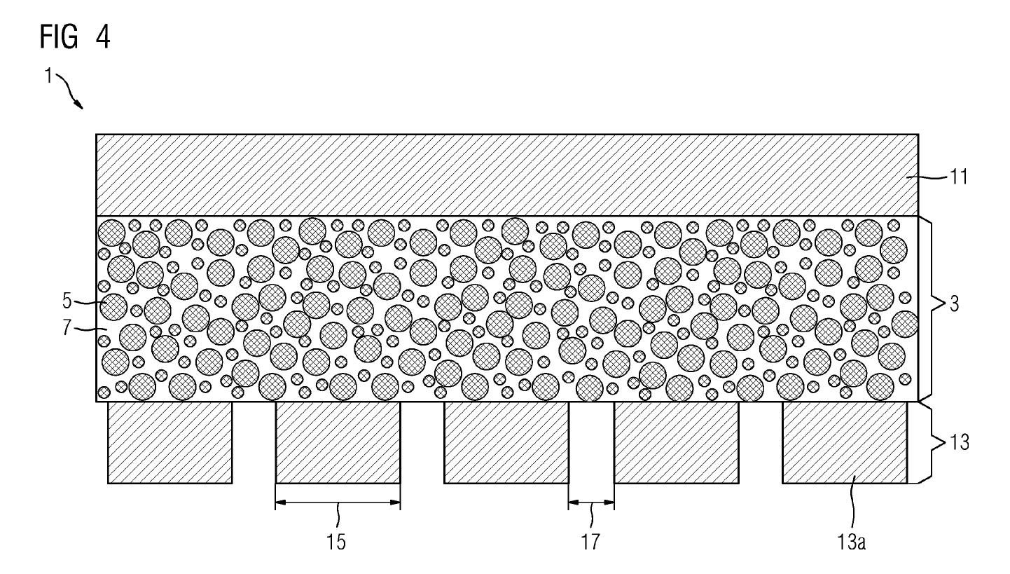

FIG. 4 shows a further conversion film 1 in accordance with a fourth exemplary embodiment of the invention in which likewise an upper electrode 11 and a lower electrode 13 are applied to opposite sides of the conversion layer 3. In this example, the lower electrode 13 is structured in a plurality of partial electrodes 13a of which five are exemplified in the figure. The lower surface of the film is structured in a regular arrangement in both its spatial directions in such partial electrodes 13a. The structure of the lower electrode may, for example, be obtained by means of laser structuring of a laminated film or also by means of lithographic structuring. The division of one of the two electrodes into a plurality of partial electrodes 13a makes pixelated readout of the physical distribution of the ionizing radiation possible, hence for example, of the production of an X-ray image. The pixel width is determined by the width 15 of the partial electrodes and the pixel distance is determined by the distance 17 of the partial electrodes. The so-called pixel pitch, that is to say, the spatial repeat length, is the sum of the width 15 and distance 17. The readout of a pixelated image does not require both electrodes to be structured. The electrical signal must only be separated into pixels on one side of the conversion layer 3. Either the anode can be structured and the cathode full-surface in design or vice versa. In any case, the conversion layer 3 can be an unstructured flat layer, and nevertheless a locally resolved image is obtained that is sharper than when a traditional image amplifier foil with a photosensor is coupled. This is made possible by the spatially directed extraction of the charge carrier when applying a bias voltage to the opposing electrodes 11 and 13.

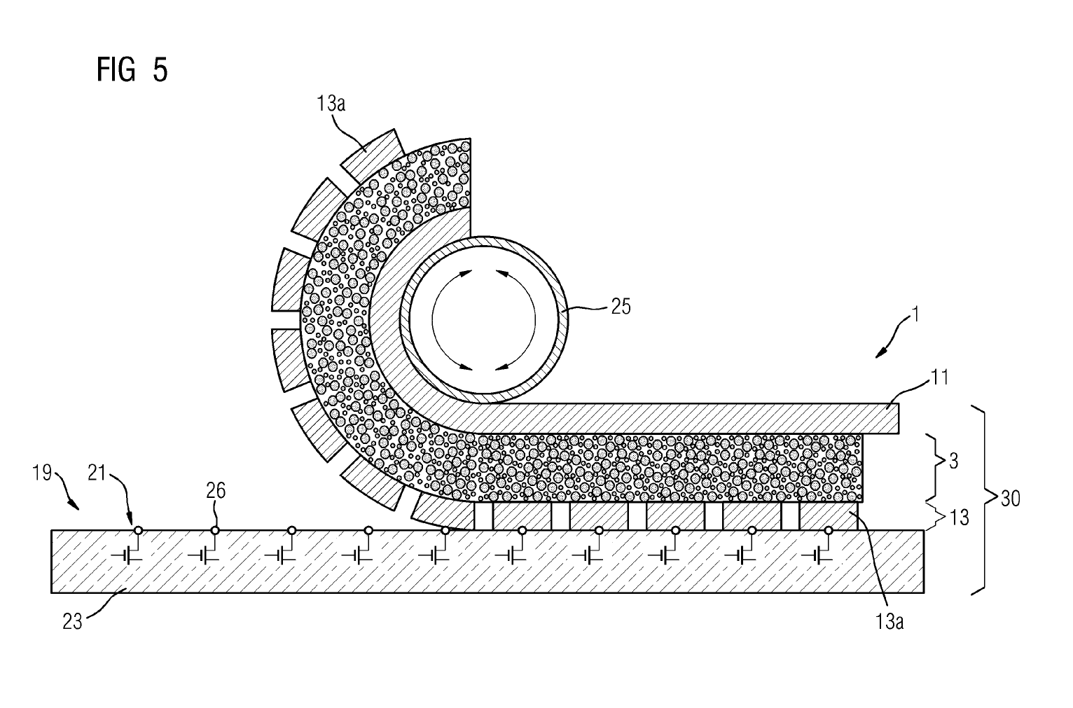

FIG. 5 finally shows a possible process step for the application of the conversion film 1 of the fourth exemplary embodiment to a transistor substrate 19. The transistor substrate 19 comprises an arrangement of a plurality of thin-film transistors 21 on a glass substrate 23. Here, for example, transistors of amorphous silicon can be used, like those used to control flat-screen displays. The inherently stable conversion film 1 with its structured lower electrode 13 can now be applied to the transistor substrate 19 by means of a roller 25 and be laminated thereto, for example, by means of the action of pressure and/or increased temperature. For this purpose, the grid of the thin-film transistor should be adjusted to the grid of the structured electrode 13 in both spatial directions of the film. However, no precise spatial alignment of the conversion film 1 with the transistor substrate 19 is necessary as only one spatially relatively small bonding point 26 of the transistors 19 need be brought into electrical contact with the respective partial electrode 13a. A certain spatial offset with regard to a central bond or another ideal position can be readily accepted without impairing functionality.

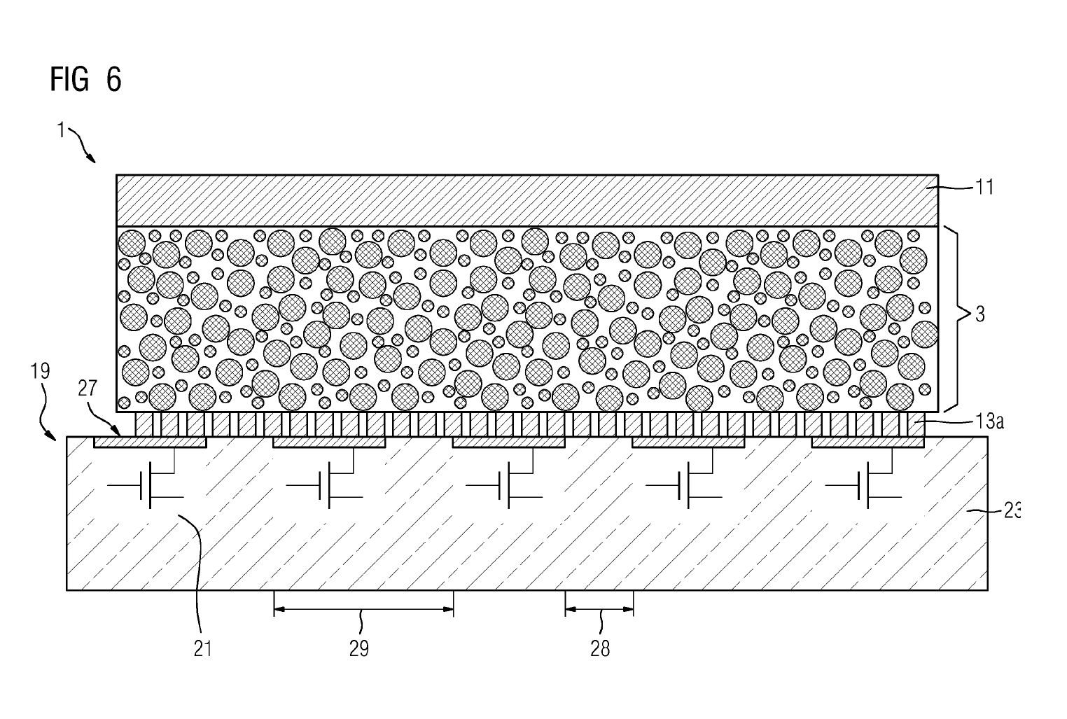

The partial electrodes 13a on the conversion film 1 may also be significantly smaller than the pixel pitch of the transistor matrix. A corresponding fifth exemplary embodiment is shown in FIG. 6. Each of the transistors 21 has extensive contact surfaces 26. The partial electrodes 13a are smaller in size in both spatial directions of the surface than the space 28 between the contact surfaces 26. As a result, the alignment of the two elements is not critical at all. The typical pixel pitch 29 of a detector for ionizing radiation is between 30 and 300 μm. The space 28 between two adjacent pixels is typically between 2 and 20% of the pixel size, typically therefore between 0.6 and 60 μm. If a correspondingly small size is selected for the partial electrodes 13a, for example, half of the space 28 (that is to say, between 0.3 and 30 μm), smooth bonding is possible without generating a short circuit between adjacent contact surfaces 27.

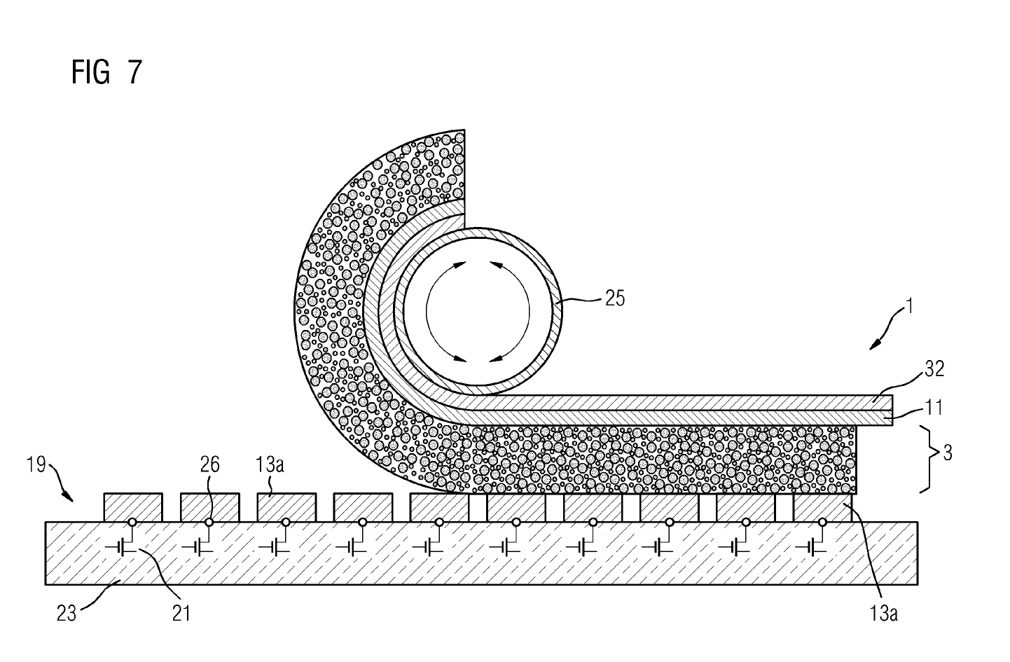

Furthermore, it is possible to produce a conversion film 1 with only one extensive electrode 11 on one side of the conversion layer 3. On the opposite side the conversion layer 3 can then be freely accessible and contacted extensively. In particular, the conversion layer 3 can then be bonded on this contactable side to a transistor matrix on which the structured contacts 13a are already applied to the transistors 21 and are conductively connected to their bonding points 26. This process of bonding is shown in exemplary fashion in FIG. 7 for a sixth exemplary embodiment of the invention. The conversion film 1 of this sixth exemplary embodiment comprises a conversion layer 3 which is arranged on a carrier film 32. This carrier film confers additional mechanical stability on the conversion film 1. An extensive, unstructured first electrode 11 is arranged between the carrier film 1 and the conversion layer. On the opposite side the conversion layer 3 is exposed. In the process step portrayed, it is connected on this exposed side to the structured partial electrodes 13a which are already applied to a transistor substrate 19 in a regular arrangement on the individual transistors 21. The connection is also established in this example through application by means of a roller 25, for example, here too under the influence of pressure and/or increased temperature again.

Finally, it is also possible to execute the contact between the conversion layer 3 and the contact points 26 of the transistors 21 as an extensive contact with anisotropic conductive properties. The contact can be designed as an anisotropic conductive film or adhesive. To process a conversion film with anisotropic contact, the film is brought into contact with the transistor matrix and anisotropic bonding is generated through the exertion of pressure and/or temperature. As a result, the electrical crosstalk between two adjacent contacts is minimized.

The radiation detector 30 arising as a result of the flat connection of the conversion film 1 and the transistor substrate 19 finally enables the detection of a locally resolved image of the ionizing radiation striking the conversion film 1. The respective partial electrodes 13a are each controlled and read out by a thin-film transistor 21. Higher-level control and readout electronics not shown here can be used to apply a defined bias voltage between the two electrodes for each pixel, to control the pixels or groups of pixels (for example, lines or columns) in succession and for each of the individual pixels to readout an electrical signal which depends on the number of charge carriers extracted from the respective partial electrodes 13a.

The present invention thus enables the simplified and modular production of a radiation detector 30 with a high process yield. The radiation detector 30 is suitable for obtaining local high-resolution images with simultaneously high conversion efficiency for ionizing radiation.

What is claimed is:

1. A conversion film for converting ionizing radiation into light and for producing charge carriers by means of the light, the conversion film comprising:
a conversion layer having a plurality of scintillator particles embedded in a binder,
wherein the binder contains at least one first organic semiconductor material.

2. The conversion film of claim 1, wherein the conversion layer is inherently stable.

3. The conversion film of claim 1, wherein the conversion layer is arranged on a carrier film.

4. The conversion film of claim 1, wherein the conversion layer is surface contactable on at least one surface.

5. The conversion film of claim 1, wherein the binder contains at least two different organic semiconductor materials, of which the first semiconductor material is an electron donor and the second semiconductor material is an electron acceptor.

6. The conversion film of claim 5, wherein at least one section of the binder comprises an interpermeating network of domains of the electron donor and domains of the electron acceptor.

7. The conversion film of claim 1, wherein the binder has an average absorption coefficient of at least 10³ cm⁻¹ for light produced by the scintillator particles.

8. The conversion film of claim 1, wherein an average particle size of the scintillator particles is between 0.1 μm and 500 μm.

9. The conversion film of claim 1, wherein the conversion layer is a layer sintered from a powder.

10. The conversion film of claim 1, wherein a proportional weight of the scintillator particles is between 80% and 98% of the conversion layer.

11. The conversion film of claim 1, wherein the binder comprises at least one polymeric material.

12. The conversion film of claim 1, wherein a thickness of the conversion layer is between 10 μm and 1 mm.

13. The conversion film of claim 1, wherein at least one electrode is arranged on at least a first surface of the conversion layer.

14. A radiation detector for detecting ionizing radiation, the radiation detector comprising:
a conversion film configured to convert ionizing radiation into light and for producing charge carriers by means of the light, the conversion film comprising:
a conversion layer having a plurality of scintillator particles embedded in a binder,
wherein the binder contains at least one first organic semiconductor material.

15. A method for producing a conversion film configured to convert ionizing radiation into light and for producing charge carriers by means of the light, wherein the conversion film comprises a conversion layer having a plurality of scintillator particles embedded in a binder containing at least one first organic semiconductor material, the method, comprising:
producing a mixture from a plurality of scintillator particles and a binder containing an organic semiconductor material,
producing a stratiform structure from the mixture, and
forming a conversion layer through solidification of the stratiform structure.
